(19) United States
(12) Patent Application Publication
(10) Pub. No.: US 2015/0204119 A1
(43) Pub. Date: Jul. 23, 2015

(54) SNAP-CLOSING DEVICE FOR DOORS AND HATCHES, COMPRISING MEANS FOR RELEASING THE HANDLE FROM THE LOCK BLOCK

(71) Applicant: F.A.P. S.R.L., Firenze (IT)

(72) Inventor: Massimo ERMINI, Firenze (IT)

(21) Appl. No.: 14/602,831

(22) Filed: Jan. 22, 2015

(30) Foreign Application Priority Data
Jan. 23, 2014 (IT) FI2014A000011

(51) Int. Cl. E05C 1/12

(52) U.S. Cl. CPC E05C 1/12

(57) ABSTRACT

A snap-closing device for doors and hatches, with particular reference to the doors and hatches of motor vehicles such as vans, caravans, motorcaravans and the like, which allows, under the condition of lock closed, the activation handle to be released from the closing sliding bar.

### RELATED APPLICATION

This application claims the benefit of Italian Patent Application No. FI2014A000011 filed Jan. 23, 2014 entitled “Snap-closing device for doors and hatches, comprising means for releasing the handle from the lock block” the disclosures of which is hereby incorporated by reference.

### FIELD OF THE INVENTION

The present invention relates to the field of closing systems and of safety locks for doors and hatches, in particular for doors and hatches of motor vehicles, especially concerning vans, caravans, motorcaravans and the like.

### STATE OF THE ART

In the field of closing systems and safety locks for doors and hatches, snap-closing devices are available on the market, which generally comprise a lock body, applied integrally to the door or hatch being examined, which houses a shaft adapted to guide a closing sliding bar. An activation handle, for example of the lever type, is associated with said shaft, held in closed position by suitable elastic means, and is adapted to activate it by pushing it in axial direction so as to open the lock which it is part of.

Said activation handle is also generally provided with a cylinder lock, or similar key locking means, which makes the locking thereof possible.

Generally, in snap-closing systems in use in the field of closing systems and of safety locks for doors and hatches, and in particular in the field of doors and hatches of motor vehicles such as vans, caravans, motorcaravans and the like, the closing system of the type described provides for said shaft, which is integral with said activation handle, to be integral with the closing sliding bar. For this reason, when the lock is locked, for example by means of the action of said cylinder or similar locking means, the activation handle remains blocked together with the shaft which is integral thereto. The handle itself may thereby be damaged in any attempts to force it by exerting strong pressures thereon in the attempt to release the lock from the block.

It is an object of the present patent application to introduce a snap-closing device for doors and hatches, with particular reference to the doors and hatches of motor vehicles such as vans, caravans, motorcaravans and the like, which allows increased simplicity and practicality of use to be introduced with respect to closing systems of the state of the art.

Another object of the present invention consists in introducing a snap-closing device for doors and hatches, with particular reference to the doors and hatches of motor vehicles such as vans, caravans, motorcaravans and the like, which allows, under the condition of lock closed, the activation handle to be released from the shaft adapted to guide the closing sliding bar.

The closing device object of the present invention allows application to the doors of vans, caravans, motorcaravans and the like and is characterized in that it has a simplified structure with respect to similar devices of the state of the art.

### BRIEF DESCRIPTION OF THE DRAWINGS

FIG. 1 shows a sectional view of the closing device according to the present invention, with the activation handle in closed position, with the lock open.

FIG. 2 shows a sectional view of the closing device according to the present invention, with the activation handle in open position, with the lock open.

FIG. 3 shows a sectional view of the closing device according to the present invention, with the activation handle in closed position, with the lock closed.

FIG. 4 shows a sectional view of the closing device according to the present invention, with the activation handle in open position, with the lock closed.

### SUMMARY OF THE INVENTION

The present invention relates to a snap-closing device for doors and hatches, with particular reference to the doors and hatches of motor vehicles such as vans, caravans, motorcaravans and the like, which allows, under the condition of lock closed, the activation handle to be released from the closing sliding bar.

### DETAILED DESCRIPTION OF THE INVENTION

The present description and accompanying drawings are to be considered as illustrative and non-limiting of the present invention, which may be implemented according to other and different embodiments, always forming a part of the appended claims, which also form an integral part of the text.

With reference to the accompanying drawings, the snap-closing device object of the present patent application comprises: an inner lock body 14 and an outer lock body 10, associated to each other by means of suitable fastening means or made in a single piece, comprising fastening means adapted to promote the installation thereof on a door or hatch such as, for example, screws and threaded seats.

Said outer lock body 10 comprises, in turn, a handle 11 associated with a specific seat 12, adapted to house said handle 11 when said handle 11 is in closed position and to allow a user to introduce the ends of his/her fingers between the bottom of said seat 12 and said handle 11, and a key locking device 13, preferably of the cylinder type.

Said inner lock body 14 comprises, in turn, a sliding bar 19 associated with said handle 11 and adapted to translate parallel to the surface of said door so as to engage with specific backing means on the frame of said door, said sliding bar 19 being associated with elastic means adapted to hold said sliding bar 19 in closed position and to withstand the movement of said sliding bar 19 in the opposite sense. Said elastic means preferably comprise a compression spring which is integral, at one end, with the end of said sliding bar 19 inside said lock body 14, and at the other end with the structure of said inner lock body 14.

Advantageously, said sliding bar 19 further comprises one end provided with a profile adapted to slide on the corresponding profile of said specific backing means on the frame of said door.

In a preferred embodiment of the present invention, said handle 11 is associated with a control shaft 15, preferably with a flat shaped end, adapted to engage with a specific housing 16 inside said sliding bar 19, and provided with an abutment 18. Said abutment 18 is provided, in turn, with an opening 17 larger in size than the thickness of the end of said control shaft 15.

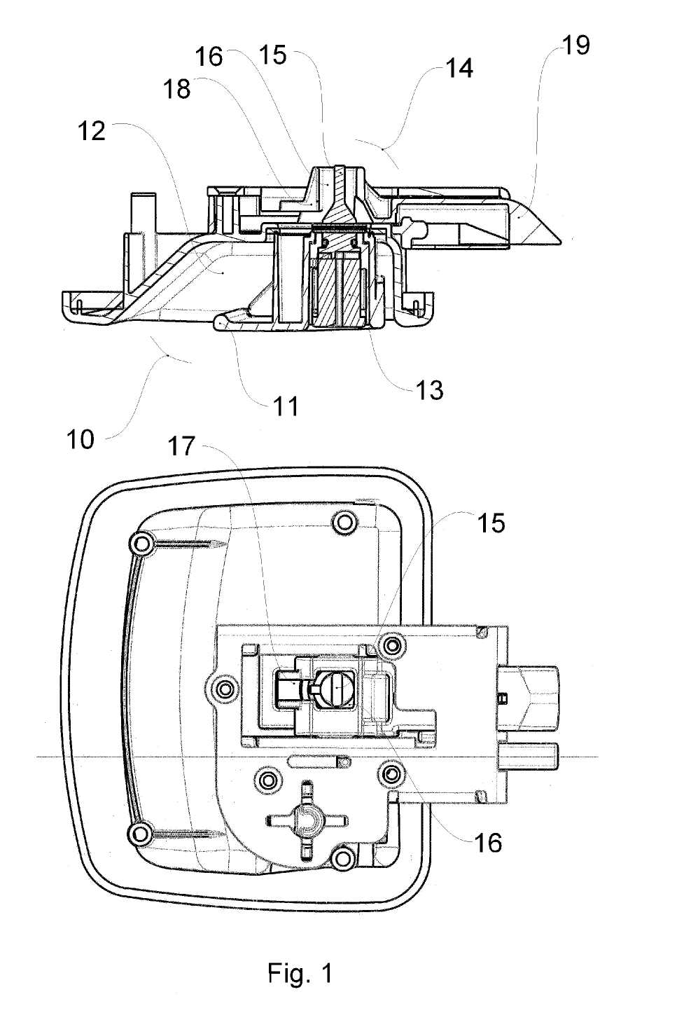

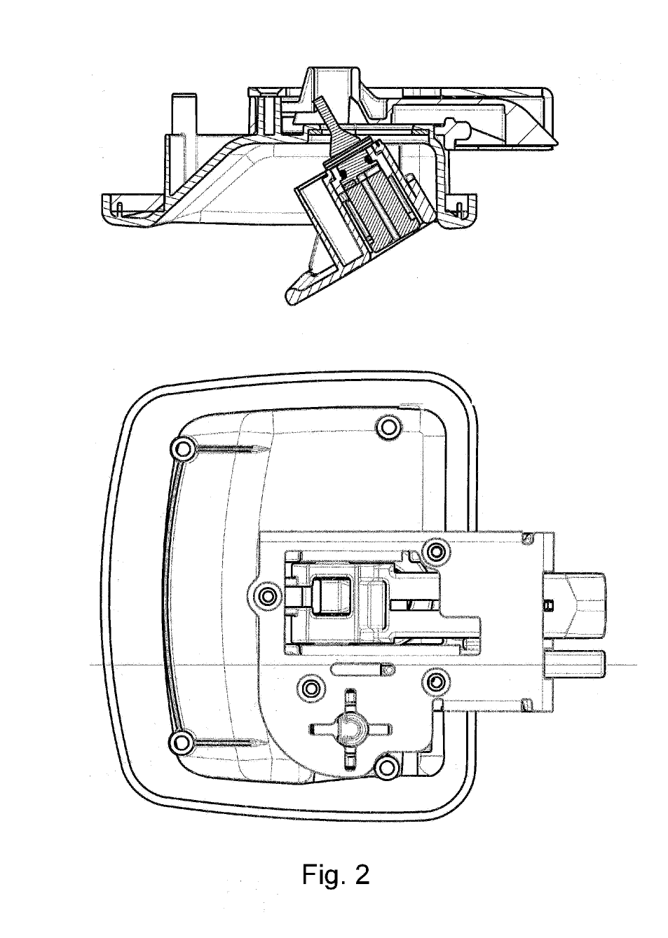

To obtain the opening of the lock, said handle 11, extracted from seat 12 by the user, activates said control shaft 15 so as to exert a pressure on said abutment 18 such as to overcome the resistance of the elastic means associated with said sliding bar 19, as shown in accompanying FIGS. 1 and 2. Thereby, the translation is caused of said sliding bar 19, parallel to the surface of said door, in a sense such as to disengage the lock from the counterpart arranged on the door and therefore to allow the opening of said door.

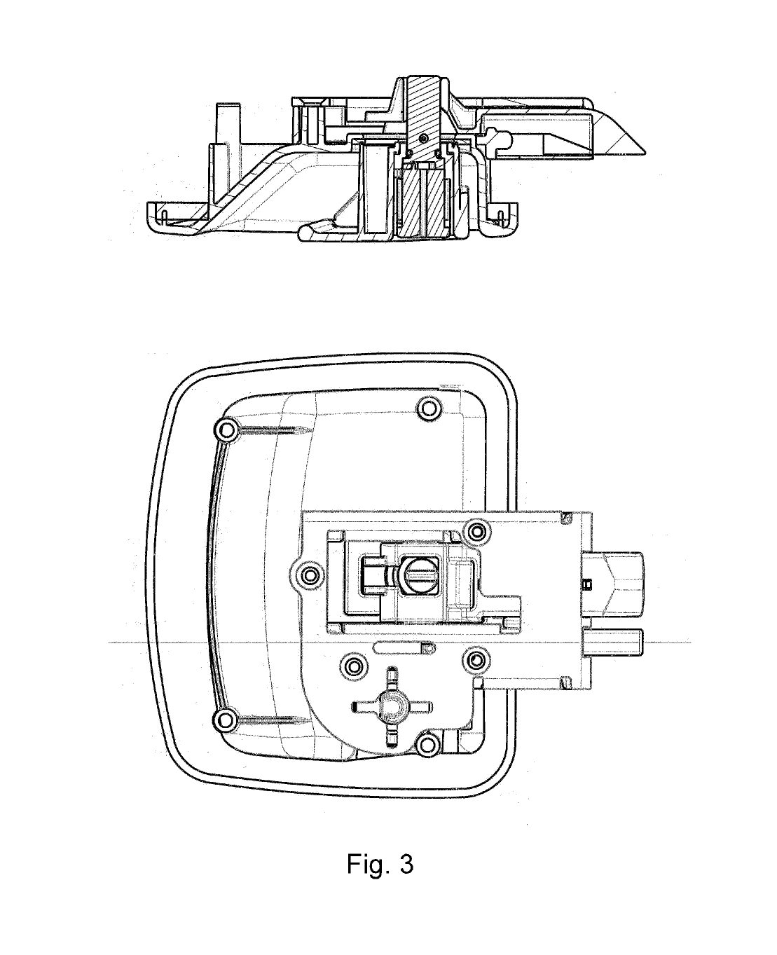

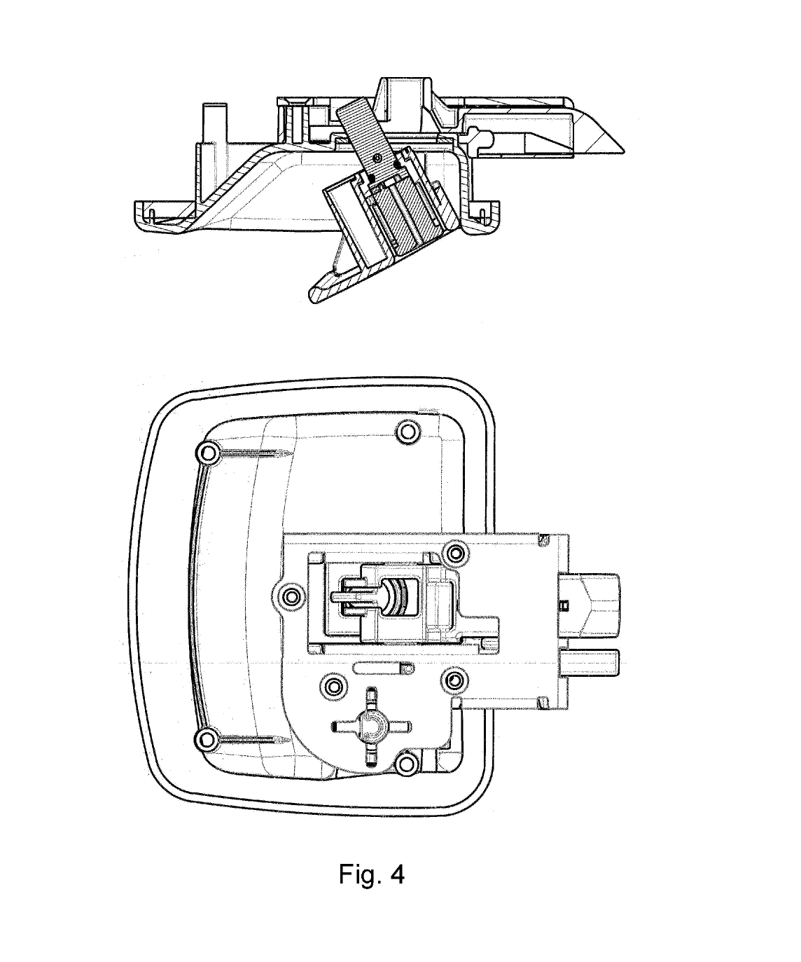

When the lock of the device according to the present invention is locked, by means of, for example, cylinder 13 housed in said handle 11, said shaft 15 is guided by said cylinder 13 and is rotated approximately by 90°. Thereby, as shown in accompanying FIGS. 3 and 4, when said handle is activated by the user and extracted from seat 12, the flat end of said shaft 15, which is integral with said handle 11, may pass through opening 17 of said abutment, thus in fact releasing said handle 11 from the sliding bar 19, thus leaving it free to be extracted from seat 12 also when the lock is locked.

According to the present invention, handle 11 of lock is therefore released from the lock when said lock is locked. Thereby, said handle 11 does not provide the possibility of forcing the lock by exerting strong pressures on handle 11 in the attempt to release the lock from the locking.

In addition to this, the device according to the present invention is easy to make, thus minimizing components and assembly times.

The preferred embodiment described and illustrated in the accompanying drawings is to be considered as exemplary and non-limiting with respect to alternative embodiments using the same inventive concept. To this end, different key closing systems may also be used in the present invention, provided that in the closed condition, shaft 15, integral with said handle 11, is in a position such as not to transmit a possible stress on handle 11 at abutment 18.

What we claim is:

1. A snap-closing device for doors and hatches comprising an inner lock body with respect to the door and an outer lock body with respect to the door, said outer lock body comprising, in turn, a handle and a key locking device, said inner lock body comprising, in turn, a sliding bar adapted to translate parallel to the surface of said door so as to engage specific backing means on said door, wherein said handle is associated with said sliding bar by means of a control shaft associated, in turn, with said key locking device and adapted to transmit a traction exerted on said handle to said sliding bar only when said key locking device is in the open position, characterized in that said control shaft comprises a flat shaped end, adapted to engage a housing inside said sliding bar and provided with an abutment provided, in turn, with an opening larger in size than the thickness of the end of said control shaft (15).

2. The device according to claim 1, wherein said sliding bar is associated with elastic means adapted to hold said sliding bar in closed position and to withstand the movement of said sliding bar in the opposite sense.

3. The device according to claim 2, wherein said elastic means preferably comprise a compression spring which is integral, at one end, with the end of said sliding bar inside said lock body, and at the other end with the structure of said inner lock body.

4. The device according to claim 1, wherein said sliding bar comprises one end provided with a profile adapted to slide on the corresponding profile of said appropriate backing means on the frame of said door.

5. The device according to claim 1, wherein said handle is associated with a specific seat, adapted to house said handle when said handle is in closed position and to allow a user to introduce the ends of his/her fingers between the bottom of said seat and said handle.

6. The device according to claim 1, wherein said key locking device is of the cylinder type.
